(19) United States
(12) Patent Application Publication
(10) Pub. No.: US 2024/0410743 A1
(43) Pub. Date: Dec. 12, 2024

(54) OPTICAL FIBER REAL-SPACE DISTRIBUTION CALCULATION SYSTEM, REAL-SPACE DISTRIBUTION CALCULATION METHOD, AND COMPUTER-READABLE MEDIUM

(71) Applicant: NEC Corporation, Minato-ku, Tokyo (JP)

(72) Inventors: Wataru KOHNO, Tokyo (JP); Tomoyuki Hino, Tokyo (JP); Reishi Kondo, Tokyo (JP); Saklko Mishima, Tokyo (JP)

(73) Assignee: NEC Corporation, Minato-ku, Tokyo (JP)

(21) Appl. No.: 18/698,116

(22) PCT Filed: Oct. 15, 2021
(86) PCT No.: PCT/JP2021/038210

§ 371 Date: Apr. 3, 2024

(51) Int. Cl. G01H 9/00

(52) U.S. Cl. CPC G01H 9/006

(57) ABSTRACT

This optical fiber real-space distribution calculation system includes propagation signal output means outputting a propagation signal propagating in a non-contact manner via a vibration medium to an optical fiber; reception time difference calculation means calculating a reception time difference of the propagation signal between adjacent measurement points; coordinate information acquisition means acquiring coordinates of a measurement point on the optical fiber and coordinates of the propagation signal output means; and measurement point calculation means calculating coordinates of each measurement point on the optical fiber by repeating calculation of an intersection between a circle centered on coordinates of the measurement point with a distance of the predetermined length segment as a radius and a circle centered on coordinates of the propagation signal output means as a next measurement point adjacent to the current measurement point, based on the calculated reception time difference of the propagation signal.

### TECHNICAL FIELD

The present invention relates to an optical fiber real-space distribution calculation system, a real-space distribution calculation method, and a computer-readable medium that calculate a distribution of an optical fiber in real space.

### BACKGROUND ART

An optical fiber real-space distribution calculation system for calculating a distribution of an optical fiber in real space is known (for example, refer to Patent Literature 1).

### CITATION LIST

### Patent Literature

Patent Literature 1: Japanese Unexamined Patent Application Publication No. 2018-194372

### SUMMARY OF INVENTION

### Technical Problem

However, in the above-described system, since linearity of the optical fiber is not taken into consideration, it is difficult to highly accurately determine a distribution of the optical fiber having high linearity.

An object of the present disclosure is to provide an optical fiber real-space distribution calculation system, a real-space distribution calculation method, and a computer-readable medium that solve the above-described problem.

### Solution to Problem

One aspect of the present invention for achieving the above-described object is an optical fiber real-space distribution calculation system including:
a propagation signal output means for outputting, to an optical fiber in which a plurality of measurement points are set for each predetermined length segment, a propagation signal propagating in a non-contact manner via a vibration medium;
a reception time difference calculation means for calculating a reception time difference of the propagation signal from the propagation signal output means between adjacent measurement points;
a coordinate information acquisition means for acquiring coordinates of a measurement point on the optical fiber and coordinates of the propagation signal output means; and
a measurement point calculation means for calculating coordinates of each measurement point on the optical fiber by recursively repeating calculation of an intersection between a circle centered on coordinates of the measurement point and having a distance of the predetermined length segment as a radius and a circle centered on coordinates of the propagation signal output means as a next measurement point on the optical fiber adjacent to the current measurement point, based on the reception time difference of the propagation signal calculated by the reception time difference calculation means.

One aspect of the present invention for achieving the above-described object is an optical fiber real-space distribution calculation method including:
a step of acquiring coordinates of a propagation signal output means for outputting, to an optical fiber in which a plurality of measurement points are set for each predetermined length segment, a propagation signal propagating in a non-contact manner via a vibration medium, and coordinates of a measurement point on the optical fiber; and
a step of calculating coordinates of each measurement point on the optical fiber by recursively repeating calculation of an intersection between a circle centered on coordinates of the measurement point and having a distance of the predetermined length segment as a radius and a circle centered on coordinates of the propagation signal output means as a next measurement point on the optical fiber adjacent to the current measurement point, based on a reception time difference of the propagation signal from the propagation signal output means between the current measurement point and the next measurement point.

One aspect of the present invention for achieving the above-described object is a non-transitory computer-readable medium storing a program for causing a computer to execute:
processing of acquiring coordinates of a propagation signal output means for outputting, to an optical fiber in which a plurality of measurement points are set for each predetermined length segment, a propagation signal propagating in a non-contact manner via a vibration medium, and coordinates of a measurement point on the optical fiber; and
processing of calculating coordinates of each measurement point on the optical fiber by recursively repeating calculation of an intersection between a circle centered on coordinates of the measurement point and having a distance of the predetermined length segment as a radius and a circle centered on coordinates of the propagation signal output means as a next measurement point on the optical fiber adjacent to the current measurement point, based on a reception time difference of the propagation signal from the propagation signal output means between the current measurement point and the next measurement point.

### Advantageous Effects of Invention

According to the present disclosure, it is possible to provide an optical fiber real-space distribution calculation system, a real-space distribution calculation method, and a computer-readable medium that solve the above-described problem.

### BRIEF DESCRIPTION OF DRAWINGS

FIG. 1 is a diagram illustrating an optical fiber according to the present example embodiment;

FIG. 2 is a block diagram illustrating a schematic system configuration of a real-space distribution calculation system according to the present example embodiment;

FIG. 3 is a diagram illustrating a method for calculating the coordinates of each measurement point on the optical fiber;

FIG. 4 is a flowchart illustrating a flow of the method for calculating the coordinates of each measurement point on the optical fiber;

FIG. 5 is a diagram illustrating a result of comparison made between a measurement point estimated by the real-space distribution calculation system according to the present example embodiment and an actual measurement point;

FIG. 6 is a flowchart illustrating a flow of a real-space distribution calculation method according to the present example embodiment;

FIG. 7 is a diagram illustrating a variation in a reception time difference of a propagation signal;

FIG. 8 is a block diagram illustrating a schematic system configuration of the real-space distribution calculation system according to the present example embodiment;

FIG. 9 is a diagram illustrating a propagation signal output unit disposed at a beginning end point of an optical fiber;

FIG. 10 is a diagram illustrating an optical fiber linearly disposed along a straight fence; and

FIG. 11 is a diagram illustrating a method for suppressing a variation of each measurement point on an optical fiber.

### EXAMPLE EMBODIMENT

### First Example Embodiment

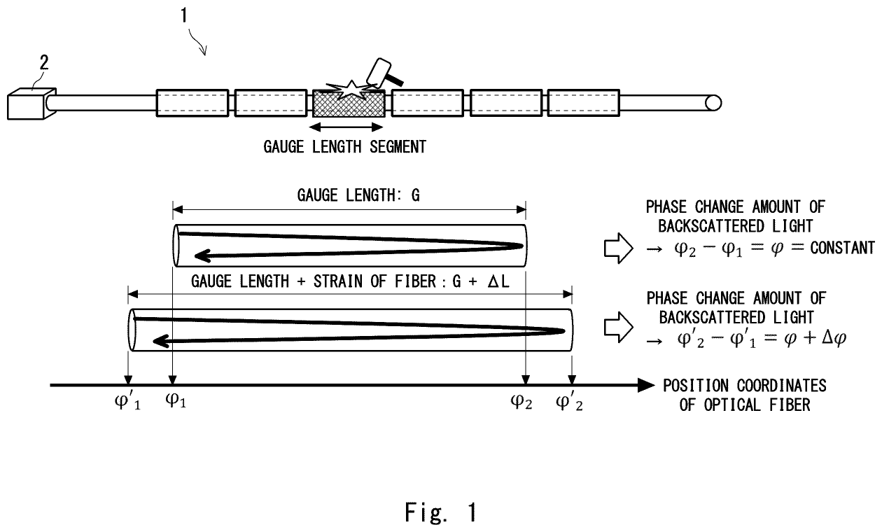

Hereinafter, example embodiments of the present invention are described with reference to the drawings. FIG. 1 is a diagram illustrating an optical fiber according to the present example embodiment. The optical fiber real-space distribution calculation system according to the present example embodiment calculates the distribution of an optical fiber 1 in real space.

In the optical fiber 1, each of a plurality of measurement points is set for each predetermined length segment (gauge length segment). Time synchronization is completed between adjacent measurement points. Therefore, the adjacent measurement points may be regarded as synchronized adjacent acoustic sensors.

An optical fiber sensor 2 is provided at an end portion of the optical fiber 1. The optical fiber sensor 2 measures a strain ΔL of the optical fiber 1 through a phase difference Δφ of backscattered light in a gauge length segment. The optical fiber 1 operates as an independent vibration/acoustic sensor in each gauge length segment.

From a relationship between an acoustic signal detected on the optical fiber 1 and real-space distribution information about the optical fiber 1, for example, the position and direction of a vibration source such as a drone may be estimated. Herein, although vibration may be detected in any segment on the optical fiber 1 by optical fiber sensing, as described above, in order to estimate the position and direction of a vibration source in real space, the real-space distribution of the optical fiber 1 is required. The real-space distribution calculation system according to the present example embodiment calculates the real-space distribution of the optical fiber 1 as described below.

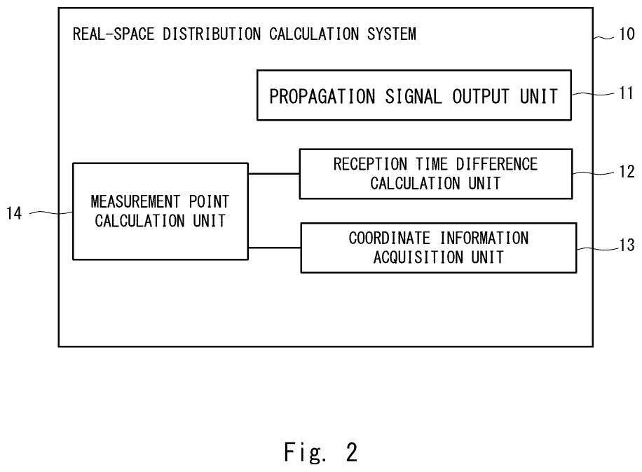

FIG. 2 is a block diagram illustrating a schematic system configuration of the real-space distribution calculation system according to the present example embodiment. As described later, a real-space distribution calculation system 10 according to the present example embodiment calculates each measurement point on the optical fiber 1 and calculates the real-space distribution of the optical fiber 1.

Note that, the real-space distribution calculation system 10 has a hardware configuration of an ordinary computer including, for example, a processor such as a central processing unit (CPU) or a graphics processing unit (GPU), an internal memory such as a random access memory (RAM) or a read only memory (ROM), a storage device such as a hard disk drive (HDD) or a solid state drive (SSD), an input/output interface (I/F) for connecting a peripheral device such as a display, and a communication I/F for communicating with an external device.

The real-space distribution calculation system 10 according to the present example embodiment includes a propagation signal output unit 11 configured to output a propagation signal, a reception time difference calculation unit 12 configured to calculate a reception time difference of the propagation signal, a coordinate information acquisition unit 13 configured to acquire coordinate information, and a measurement point calculation unit 14 configured to calculate coordinates of each measurement point on the optical fiber 1. The real-space distribution calculation system 10 calculates the real-space distribution of the optical fiber 1, based on the reception time difference of the propagation signal from the propagation signal output unit 11 between measurement points on the optical fiber 1.

The propagation signal output unit 11 is a specific example of a propagation signal output means. The propagation signal output unit 11 outputs, to the optical fiber 1, a propagation signal propagating in a non-contact manner via a vibration medium. For example, two propagation signal output units 11 are provided at desired positions.

The propagation signal is a signal that is less attenuated in the process of propagation and propagates over a wide area to the optical fiber 1, and is a signal in which an arrival time difference of a signal derived from a difference in distance from a signal source to a signal measurement point occurs.

By using the above-described characteristics of the propagation signal, the real-space distribution of the optical fiber 1 in a wide range may be determined at once without contacting the optical fiber 1, as described later. In addition, when the propagation speed of the propagation signal is high, the real-space distribution of the optical fiber 1 may be determined in a short time. Therefore, for example, it is possible to easily determine the distribution of the optical fiber 1 laid on the seabed or the like being difficult to access.

The propagation signal is, for example, a sound propagating through the air, an earthquake wave propagating on the ground, or the like. The propagation signal is preferably a sudden sound (for example, a sound of a balloon bursting) having a large sound pressure and spreading over a wide area. This is because the sampling frequency of the optical fiber sensor 2 is inversely proportional to the total length of the optical fiber 1.

In a case of using a narrow-band propagation signal, it is preferable that a selection is made in such a way that the distance between measurement points is larger than half the wavelength of the sound wave. This is because such selection facilitates evaluation of the reception time difference (TDOA: time difference of arrival) between the measurement points.

The reception time difference calculation unit 12 is a specific example of a reception time difference calculation means. The reception time difference calculation unit 12 calculates a reception time difference of a propagation signal output from the propagation signal output unit 11 between adjacent measurement points.

For example, the optical fiber sensor 2 outputs an optical signal to the optical fiber 1 at a predetermined cycle and receives the reflected signal. The reception time difference calculation unit 12 calculates a reception time at which each measurement point on the optical fiber 1 receives the propagation signal from the propagation signal output unit 11, based on the reflection signal received by the optical fiber sensor 2. Then, the reception time difference calculation unit 12 calculates a reception time difference between adjacent measurement points, thereby calculating a reception time difference of the propagation signal between the measurement points described above. Herein, the reception time difference calculation unit 12 may store the calculated reception time difference of the propagation signal between the measurement points in the internal memory or the like.

The coordinate information acquisition unit 13 is a specific example of a coordinate information acquisition means. The coordinate information acquisition unit 13 acquires coordinates of one measurement point on the optical fiber 1 and coordinates of two propagation signal output units 11. The coordinate information acquisition unit 13 acquires, for example, the coordinates of the optical fiber sensor 2 connected to the end portion of the optical fiber 1 as the coordinates of the one measurement point on the optical fiber 1. Such coordinates may be input to the coordinate information acquisition unit 13 via, for example, an input device or the like, or may be set in advance in an internal memory or the like.

The optical fiber 1 is distributed one-dimensionally and cannot be bent, and therefore has high linearity. Accordingly, based on the coordinates of a certain measurement point on the optical fiber 1, the coordinates of the next measurement point adjacent to the certain measurement point may be easily determined.

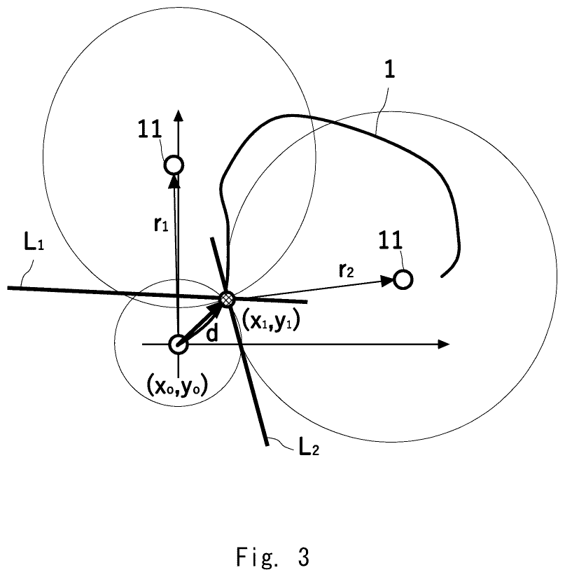

In the present example embodiment, focusing on the characteristics of the optical fiber 1, the measurement point calculation unit 14, as illustrated in FIG. 3, calculates the coordinates of each measurement point on the optical fiber 1 by recursively repeating calculation of an intersection among a circle centered on the coordinates (x₀, y₀) of the measurement point and having the distance d of the predetermined length segment as the radius and two circles centered on the coordinates of the two propagation signal output units 11 as the next measurement point (x₁, y₁) on the optical fiber 1 adjacent to the current measurement point (x₀, y₀), based on a reception time difference of the propagation signal from the propagation signal output unit 11 between the current measurement point (x₀, y₀) and the next measurement point (x₁, y₁).

As described above, by recursively acquiring coordinates of the adjacent measurement points from coordinates of a known measurement point in consideration of the linearity of the optical fiber 1, it is possible to highly accurately determine the distribution of the optical fiber 1 having high linearity.

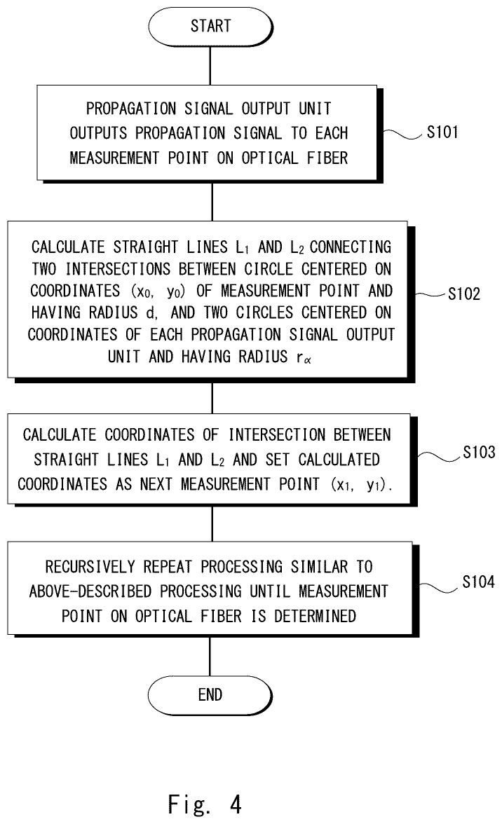

Herein, the above-described method for calculating the coordinates of each measurement point on the optical fiber 1 is described in more detail. FIG. 4 is a flowchart illustrating a flow of the above-described method for calculating the coordinates of each measurement point on the optical fiber 1.

The distance d between adjacent measurement points (predetermined length segment) of the optical fiber 1 is assumed to be a straight line. The coordinates of the measurement points on the optical fiber 1 are (xᵢ, yᵢ) (i=0, 1, 2, 3, . . . ). The coordinates of the two propagation signal output units 11 are (x_{α}^{s}, y_{α}^{s}) (α=1, 2). Each propagation signal output unit 11 outputs a propagation signal to each measurement point on the optical fiber 1 (step S101).

The measurement point calculation unit 14 is a specific example of a measurement point calculation means. The measurement point calculation unit 14 geometrically calculates an intersection among a circle centered on the coordinates (x₀, y₀) of the measurement point and having the distance d of the predetermined length segment as a radius and two circles each centered on the coordinates (x_{α}^{s}, y_{α}^{s}) of the propagation signal output unit 11 and having a radius r_{α} (FIG. 3).

Herein, r_{α}=r_{0α}+ct_{1,0,α}, and r_{iα} is a distance from the origin (xᵢ, yᵢ) to each of the propagation signal output units 11. t_{i,i-1,α} is a reception time difference between the measurement point i and the measurement point i−1 of the propagation signal from the propagation signal output units 11. c is a signal propagation speed.

Specifically, the measurement point calculation unit 14 calculates the straight lines L₁ and L₂ connecting two intersections between a circle centered on the coordinates (x₀, y₀) of the measurement point and having the distance d of the predetermined length segment as a radius, and two circles each centered on the coordinates (x_{α}^{s}, y_{α}^{s}) of the propagation signal output unit and having a radius r_{α} (step S102).

Herein, r_{α}={(x₀−x_{α}^{s})²+(y₀−y_{α}^{s})²)}^{1/2}+ct_{1,0,α}.

The measurement point calculation unit 14 calculates the coordinates of the intersection of the two straight lines L₁ and L₂. The measurement point calculation unit 14 estimates the calculated coordinates of the intersection as an intersection among a circle centered of the coordinates (x₀, y₀) of a measurement point and having the radius d and two circles each centered on the coordinates (x_{α}^{s}, y_{α}^{s}) of the propagation signal output unit 11 and having the radius r_{α}. The measurement point calculation unit 14 sets the estimated coordinates as the coordinates (x₁, y₁) of the next measurement point (step S103).

The measurement point calculation unit 14 replaces (x₀, y₀) with (x₁, y₁), and recursively repeats processing similar to the processing described above until the distribution of the measurement points on the optical fiber 1 is determined (step S104). Note that the rog is updated simultaneously with the updating of (x₀, y₀). That is, the measurement point calculation unit 14 recursively calculates (x₁, y₁), (x₂, y₂), (x₃, y₃), . . . , by using the above-described calculation method, based on the coordinates (x₀, y₀) of a known measurement point acquired by the coordinate information acquisition unit 13.

(x₀, y₀)→(x₁, y₁), (x₁, y₁)→(x₂, y₂), (x₂, y₂)→(x₃, y₃), . . . .

In a case where the first known measurement point is, for example, the coordinates of the optical fiber sensor 2 being the beginning end point of the optical fiber 1, the measurement point calculation unit 14 recursively calculates each measurement point in a single stroke from the beginning end point to the terminal end point of the optical fiber 1, based on the above-described calculation method.

Meanwhile, when the first known measurement point is, for example, an intermediate point of the optical fiber 1, the measurement point calculation unit 14 may calculate from the intermediate point to the beginning end point and then calculate from the intermediate point to the terminal end point of the optical fiber, based on the above-described calculation method.

In the description above, the measurement point calculation unit 14 calculates the coordinates of each measurement point on the optical fiber 1, based on the coordinates of one measurement point acquired by the coordinate information acquisition unit 13 and the coordinates of two propagation signal output units 11. However, the present invention is not limited thereto. The measurement point calculation unit 14 may calculate the coordinates of each measurement point on the optical fiber 1 by using a method similar to the method described above, based on the coordinates of one measurement point acquired by the coordinate information acquisition unit 13 and the coordinates of three or more propagation signal output units 11.

Further, in the description above, the measurement point calculation unit 14 calculates the two-dimensional real-space distribution of the optical fiber 1 by calculating the two-dimensional coordinates of each measurement point on the optical fiber 1. However, the measurement point calculation unit 14 may calculate the three-dimensional real-space distribution of the optical fiber 1 by calculating the three-dimensional coordinates of each measurement point on the optical fiber 1, similarly to the case of calculating the two-dimensional coordinates of each measurement point on the optical fiber 1.

In such a case, the measurement point calculation unit 14 geometrically calculates an intersection among a sphere centered on the coordinates (x₀, y₀, z₀) of a measurement point and having the distance d of the predetermined length segment as a radius and three spheres each centered on coordinates (x_{α}^{s}, y_{α}^{s}, z_{α}^{s}) of each propagation signal output unit 11 and having a radius r_{α} (α=1, 2, 3).

Specifically, the measurement point calculation unit 14 calculates planes S1, S2, and S3 each including an intersection line among a sphere centered on the coordinates (x₀, y₀, z₀) of the measurement point and having the distance d of the predetermined length segment as a radius and three spheres each centered on the coordinates (x_{α}^{s}, y_{α}^{s}, z_{α}^{s}) of the propagation signal output unit and having a radius r_{α}.

The measurement point calculation unit 14 calculates the coordinates of the intersection among the three planes S1, S2, and S3. The measurement point calculation unit 14 estimates the calculated coordinates of the intersection as the coordinates (x₁, y₁, z₁) of the next measurement point.

The measurement point calculation unit 14 replaces (x₀, y₀, z₀) with (x₁, y₁, z₁), and recursively repeats processing similar to the processing described above until the distribution of the measurement points on the optical fibers 1 is determined. That is, the measurement point calculation unit 14 recursively calculates (x₁, y₁, z₁), (x₂, y₂, z₂), (x₃, y₃, z₃), . . . , by using the above-described calculation method, based on the coordinates (x₀, y₀, z₀) of the known measurement point acquired by the coordinate information acquisition unit 13.

Note that, the measurement point calculation unit 14 may recursively calculate the three-dimensional coordinates of the measurement points on the optical fiber 1 as (x₁, y₁, z₁), (x₂, y₂, z₂), (x₃, y₃, z₃), . . . , by using the above-described calculation method, based on the three-dimensional coordinates (x₀, y₀, z₀) of one known measurement point acquired by the coordinate information acquisition unit 13 and three-dimensional coordinates of four or more propagation signal output units 11.

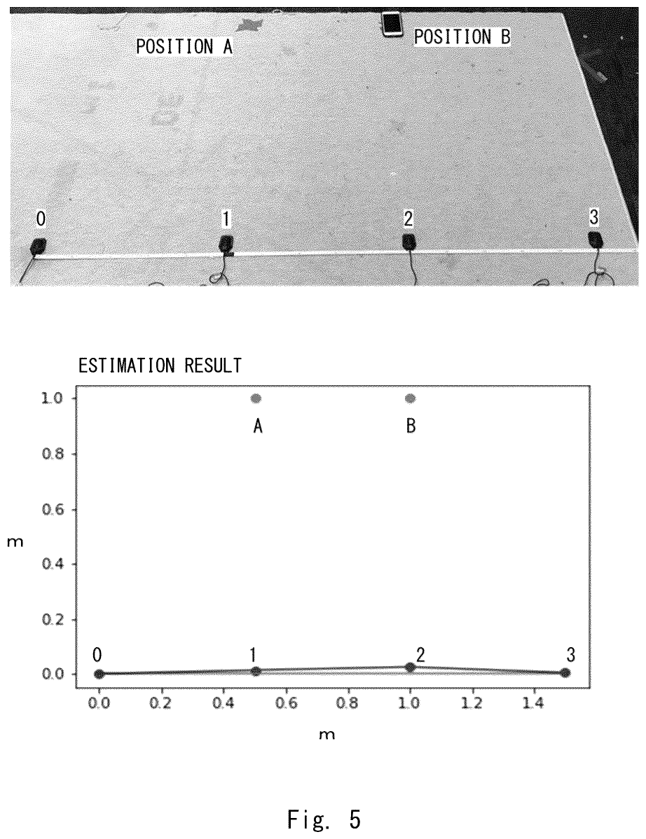

Next, a comparison between a measurement point estimated by the real-space distribution calculation system 10 according to the present example embodiment and the actual measurement point is described with reference to FIG. 5. Herein, two smartphones are used as the propagation signal output units 11, and recording of applause is output as the propagation signal. As illustrated in the upper part of FIG. 5, the smartphones are each installed at positions A and B. Microphones are each installed at measurement points 0, 1, 2, and 3 on the optical fiber 1.

The coordinates of the measurement points 0 to 3 of the microphones are (0, 0), (0.5, 0), (1.0, 0), and (1.5, 0), respectively. Such coordinates of the measurement points 0 to 3 of the microphones are the coordinates of the actual measurement point. The coordinates of the positions A and B of the smartphones are (0.5, 1.0) and (1.0, 1.0), respectively. Such coordinates of the smartphones are the coordinates of the propagation signal output units 11.

As illustrated in the lower part of FIG. 5, the measurement point estimated by the real-space distribution calculation system 10 according to the present example embodiment and the actual measurement point (solid line), although slightly differing at the measurement point 2, substantially coincide with each other. As described above, it is understood that according to the real-space distribution calculation system 10 of the present example embodiment, the distribution of the optical fiber 1 may be determined with high accuracy.

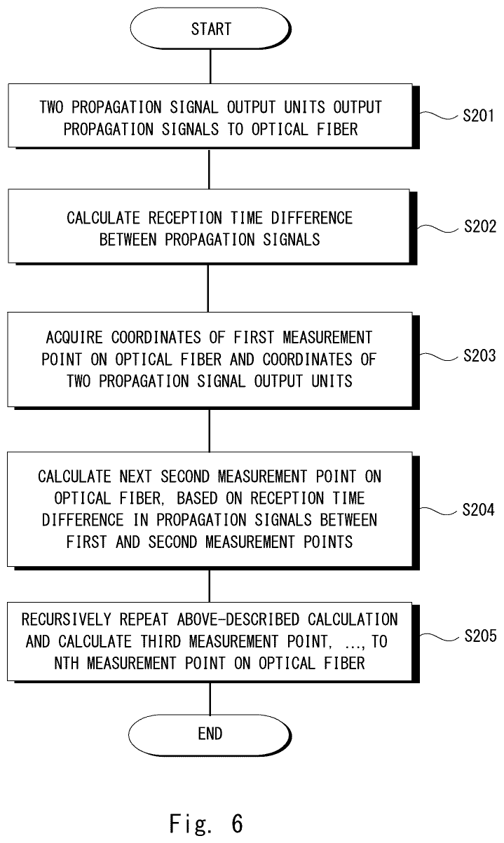

Next, a real-space distribution calculation method according to the present example embodiment is described. FIG. 6 is a flowchart illustrating a flow of the real-space distribution calculation method according to the present example embodiment.

The two propagation signal output units 11 output, to the optical fiber 1, the propagation signals propagating in a non-contact manner via the vibration medium (step S201).

The reception time difference calculation unit 12 calculates a reception time difference of a propagation signal from each propagation signal output unit 11 between adjacent measurement points (step S202).

The coordinate information acquisition unit 13 acquires the coordinates of one first measurement point on the optical fiber 1 and the coordinates of two propagation signal output units 11, and outputs the acquired coordinates to the measurement point calculation unit 14 (step S203).

The measurement point calculation unit 14 calculates an intersection between a circle centered on the coordinates of the first measurement point and having the distance of the predetermined length segment as the radius and circles centered on the coordinates of the two propagation signal output units 11, as the next second measurement point on the optical fiber 1 adjacent to the first measurement point, based on the reception time difference of the propagation signal from each propagation signal output unit 11 between the first measurement point and the second measurement point (step S204).

The measurement point calculation unit 14 calculates the coordinates of a third measurement point, a fourth measurement point, a fifth measurement point, . . . , to an Nth measurement point on the optical fiber 1 by recursively repeating the above-described calculation (step S205).

As described above, the real-space distribution calculation system 10 according to the present example embodiment calculates the coordinates of each measurement point on the optical fiber 1 by recursively repeating the calculation of an intersection among a circle cantered on the coordinates of the measurement point and having the distance of the predetermined length segment as a radius and two circles each centered on the coordinates of the two propagation signal output units 11 as the next measurement point on the optical fiber 1 adjacent to the current measurement point, based on the reception time difference of the propagation signal from the propagation signal output unit 11 between the current measurement point and the next measurement point. As a result, in consideration of the linearity of the optical fiber 1, by recursively acquiring the coordinates of the adjacent measurement points from the coordinates of the known measurement point, it is possible to highly accurately determine the distribution of the optical fiber 1 having high linearity.

### Second Example Embodiment

In the present example embodiment, a measurement point calculation unit 14 may calculate the coordinates of each measurement point on an optical fiber 1 by performing four (or less)-dimensional curve regression on a reception time difference of propagation signals calculated by a reception time difference calculation unit 12. As described above, by utilizing the linearity of the optical fiber 1 and performing four (or less)-dimensional curve regression on the reception time difference of the propagation signal, it is possible to suppress variations in the reception time difference of the propagation signals. Thus, each measurement point on the optical fiber 1 may be calculated with higher accuracy, and the real-space distribution of the optical fiber 1 may be calculated with higher accuracy.

In the first example embodiment, there is an upper limit of error in the reception time difference of the propagation signal. Specifically, it is required that a circle centered on the coordinates (xᵢ₋₁, yᵢ₋₁) of an (i−1)th measurement point and having a distance d of a predetermined upper segment as a radius has an intersection with a circle centered on the coordinates (x_{α}^{s}, y_{α}^{s}) and having a radius r_{α}, and also requires that a reception time difference of the propagation signal calculated from an ith measurement point satisfies |t_{i,i-1,α}|≤d/c. When the reception time difference of the propagation signal does not satisfy the above-described condition due to a measurement error or the like, the two circles do not have an intersection. In addition, since the measurement points are recursively calculated as described above, accumulated error tends to occur.

Meanwhile, in the present example embodiment, the measurement point calculation unit 14 performs four (or less)-dimensional curve regression on the reception time difference of the propagation signal calculated by the reception time difference calculation unit 12 as described above, by utilizing the linearity of the optical fiber 1.

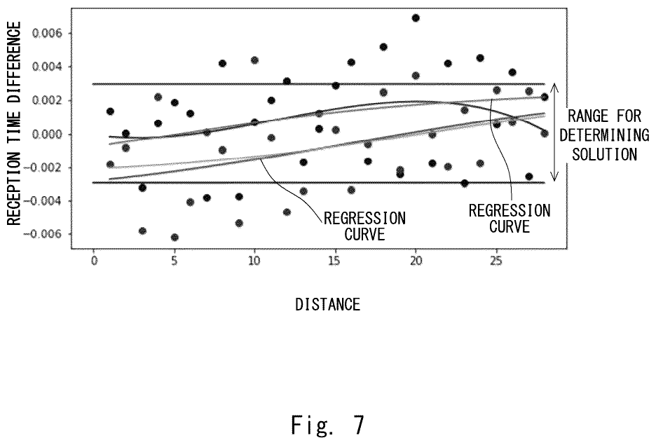

For example, in FIG. 7, the reception time difference of the propagation signal calculated by the reception time difference calculation unit 12 varies in reality as indicated by points. In FIG. 7, the horizontal axis represents the distance from an optical fiber sensor 2, and the vertical axis represents the reception time difference. When the coordinates of each measurement point on the optical fiber are determined by the reception time difference of the propagation signal assuming that d=1 m and c=340 m/sec, the reception time difference is required to fall within a range of ±1/340 seconds, as illustrated by the vertical line in FIG. 7.

However, by obtaining a regression line by performing a four (or less)-dimensional curve regression on the reception time difference of the propagation signal and correcting the reception time difference of the propagation signal, based on the regression line, it is possible to suppress the variation. Note that, the reason why two regression lines are generated is that curve regression is performed on each of the reception time differences of the propagation signals from the two propagation signal output units 11.

The measurement point calculation unit 14 corrects, for example, the reception time difference of each propagation signal to a point on the regression line as the correction of each measurement point based on the regression line. Alternatively, the measurement point calculation unit 14 may exclude a reception time difference that largely deviates from the regression line by a predetermined value or more among the reception time difference of the propagation signal calculated by the reception time difference calculation unit 12.

### Third Example Embodiment

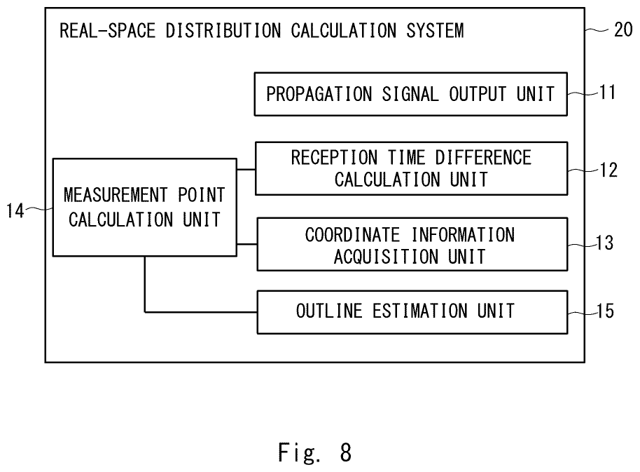

FIG. 8 is a block diagram illustrating a schematic system configuration of a real-space distribution calculation system according to the present example embodiment. A real-space distribution calculation system 20 according to the present example embodiment may further include an outline estimation unit 15 configured to estimate the outline of an optical fiber 1 by utilizing the continuity of the optical fiber 1.

By using the outline of the optical fiber 1 estimated by the outline estimation unit 15, each measurement point on the optical fiber 1 may be calculated with higher accuracy, and the real-space distribution of the optical fiber 1 may be calculated with higher accuracy. The outline estimation unit 15 is a specific example of an outline estimation means.

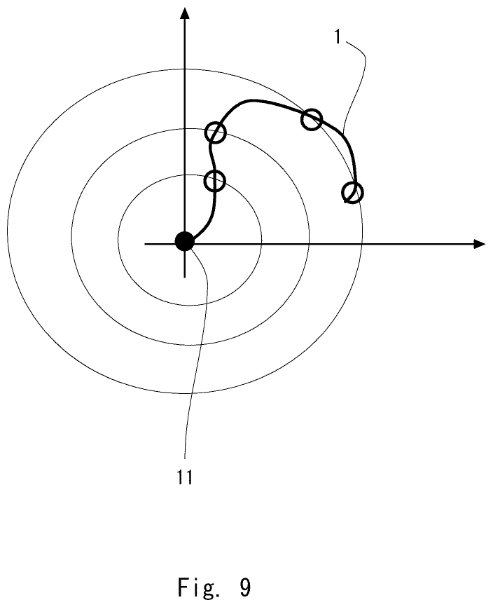

As illustrated in FIG. 9, a propagation signal output unit 11 may be disposed at a beginning end point of the optical fiber 1. For example, the propagation signal output unit 11 is disposed at the same position as an optical fiber sensor 2.

Herein, |TDOA| is a reception time difference of the propagation signal between the propagation signal output unit 11 and each measurement point. 1 is a distance on the optical fiber 1 from the propagation signal output unit 11 to a measurement point.

The outline estimation unit 15 is able to estimate the outline of the optical fiber 1 by utilizing the continuity of the optical fiber 1, as described in (1) to (3) described below.
(1) In a case where |TDOA|=1/c, the outline estimation unit 15 estimates that the optical fiber 1 is linearly distributed from the propagation signal output unit 11.
(2) In a case where |TDOA|<1/c, the outline estimation unit 15 estimates in that the optical fiber 1 is distributed in a bent state from the propagation signal output unit 11.
(3) At a point where |TDOA| becomes a maximum value, the outline estimation unit 15 estimates that the optical fiber 1 is folded back toward the propagation signal output unit 11.

A measurement point calculation unit 14 compares the calculated coordinates of each measurement point on the optical fiber 1 with the outline of the optical fiber 1 estimated by the outline estimation unit 15. When determining that a large deviation of a predetermined value or more has occurred between the calculated coordinates of each measurement point on the optical fiber 1 and the outline of the optical fiber 1 estimated by the outline estimation unit 15, the measurement point calculation unit 14 may correct the calculated coordinates of each measurement point on the optical fiber 1.

For example, the measurement point calculation unit 14 corrects the calculated coordinates of each measurement point on the optical fiber 1 to a point on the outline of the optical fiber 1 estimated by the outline estimation unit 15. Alternatively, the measurement point calculation unit 14 may exclude a point which largely deviates by a predetermined value or more from the outline of the optical fiber 1 estimated by the outline estimation unit 15 from among the calculated coordinates of each measurement point on the optical fiber 1.

### Fourth Example Embodiment

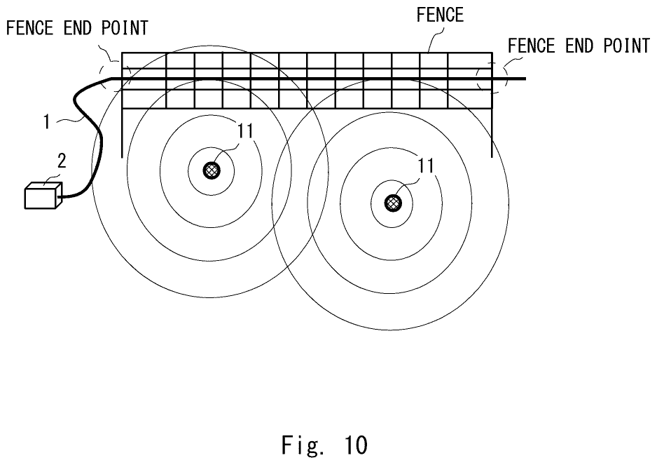

In the present example embodiment, an optical fiber 1 may be arranged linearly along a straight member. For example, as illustrated in FIG. 10, the optical fiber 1 is linearly arranged along a straight fence.

For example, when an end point portion of the fence is vibrated by an exciter or the like, a coordinate information acquisition unit 13 acquires a point having the maximum amplitude value as the coordinates of the end point of the fence on the optical fiber 1. A measurement point calculation unit 14 recursively calculates each measurement point on the optical fiber 1 by using the above-described calculation method, based on the coordinates of the end point acquired by the coordinate information acquisition unit 13.

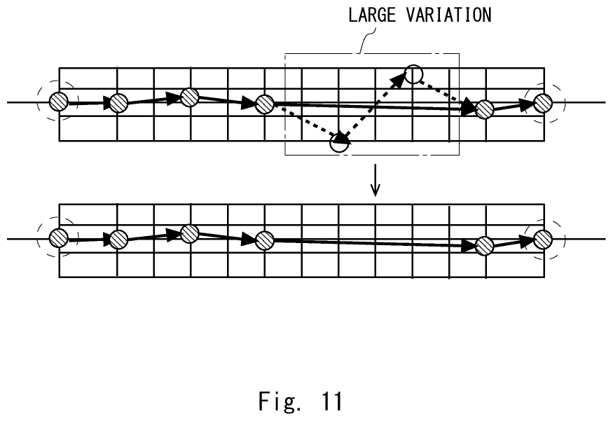

Herein, since the optical fiber 1 is arranged linearly along a straight fence, generally, the calculated measurement points are also assumed to be linear. However, as illustrated in the upper part of FIG. 11, there may be large variations among the measurement points.

Meanwhile, in the present example embodiment, the measurement point calculation unit 14 calculates the deflection angle of a line connecting calculated adjacent measurement points with respect to the linear direction of the optical fiber 1. The measurement point calculation unit 14 may exclude a measurement point at which the absolute value of the calculated deflection angle is equal to or greater than a predetermined angle from among the calculated measurement points, as illustrated in the lower part of FIG. 11.

Further, the measurement point calculation unit 14 may correct a measurement point at which the absolute value of the calculated deflection angle is equal to or greater than a predetermined angle to a point on a line in the linear direction of the optical fiber 1. As a result, each measurement point on the optical fiber 1 is calculated with higher accuracy while suppressing the variation of the measurement points, and the real-space distribution of the optical fiber 1 may be calculated with higher accuracy.

The measurement point calculation unit 14 may calculate an average value of the absolute values of the deflection angles of the measurement points, and may set such average value as the predetermined angle.

While certain example embodiments have been described, these example embodiments have been presented by way of example only, and are not intended to limit the scope of the invention. The novel example embodiments described herein may be embodied in a variety of other forms, and various omissions, substitutions and changes may be made without departing from the spirit of the invention. The example embodiments and modifications thereof fall within the scope and spirit of the invention, and fall within the scope of the invention described in the claims and equivalents thereof.

The present invention may also achieve the processing illustrated in FIG. 4 or 6, for example, by causing a processor to execute a computer program.

The program may be stored and provided to the computer by using various types of non-transitory computer-readable media. Non-transitory computer-readable media include various types of tangible storage media. Examples of non-transitory computer-readable media include a magnetic recording medium (e.g., flexible disk, magnetic tape, hard disk drive), a magneto-optical recording medium (e.g., magneto-optical disk), a CD-read only memory (ROM), a CD-R, a CD-R/W, and a semi-conductor memory (e.g., mask ROM, programmable ROM (PROM), erasable PROM (EPROM), flash ROM, random access memory (RAM)).

The program may be provided to the computer by various types of transitory computer-readable media. Examples of a transitory computer-readable medium include an electrical signal, an optical signal, and electromagnetic waves. The transitory computer-readable medium may supply the program to the computer via a wired communication path such as an electric wire and an optical fiber, or via a wireless communication path.

Each of the units constituting the real-space distribution calculation systems 10 and 20 according to the above-described example embodiments may be achieved not only by a program but also, partly or entirely, by dedicated hardware such as an application specific integrated circuit (ASIC) and a field-programmable gate array (FPGA).

### REFERENCE SIGNS LIST

1 OPTICAL FIBER
2 OPTICAL FIBER SENSOR
10 REAL-SPACE DISTRIBUTION CALCULATION SYSTEM
11 PROPAGATION SIGNAL OUTPUT UNIT
12 RECEPTION TIME DIFFERENCE CALCULATION UNIT
13 COORDINATE INFORMATION ACQUISITION UNIT
14 MEASUREMENT POINT CALCULATION UNIT
15 OUTLINE ESTIMATION UNIT
20 REAL-SPACE DISTRIBUTION CALCULATION SYSTEM

What is claimed is:

1. An optical fiber real-space distribution calculation system comprising:
propagation signal output means for outputting, to an optical fiber in which a plurality of measurement points are set for each predetermined length segment, a propagation signal propagating in a non-contact manner via a vibration medium;
reception time difference calculation means for calculating a reception time difference of the propagation signal from the propagation signal output means between adjacent measurement points;
coordinate information acquisition means for acquiring coordinates of a measurement point on the optical fiber and coordinates of the propagation signal output means; and
measurement point calculation means for calculating coordinates of each measurement point on the optical fiber by recursively repeating calculation of an intersection between a circle centered on coordinates of the measurement point and having a distance of the predetermined length segment as a radius and a circle centered on coordinates of the propagation signal output means as a next measurement point on the optical fiber adjacent to the current measurement point, based on a reception time difference of the propagation signal calculated by the reception time difference calculation means.

2. The optical fiber real-space distribution calculation system according to claim 1, wherein the measurement point calculation means calculates coordinates of each measurement point on the optical fiber by performing a four (or less)-dimensional curve regression on a reception time difference of the propagation signal calculated by the reception time difference calculation means.

3. The optical fiber real-space distribution calculation system according to claim 1, wherein
the propagation signal output means is disposed at an end point of the optical fiber,
the system further comprises outline estimation means for estimating an outline of the optical fiber by, when |TDOA| is a reception time difference of the propagation signal, I is a distance on the optical fiber from the propagation signal output means to a measurement point, and c is a speed of sound, (1) estimating, in a case where |TDOA|=1/c, that the optical fiber is distributed linearly from the propagation signal output means, (2) estimating, in a case where |TDOA|<I/c, that the optical fiber is distributed in a bent state from the propagation signal output means, and (3) estimating, at a point where |TDOA| becomes a maximal value, that the optical fiber is folded back toward the propagation signal output means, and
the measurement point calculation means compares the calculated coordinates of each measurement point on the optical fiber with an outline of the optical fiber estimated by the outline estimation means.

4. The optical fiber real-space distribution calculation system according to claim 1, wherein, in a case where the optical fiber is linearly disposed along a straight member, the measurement point calculation means calculates a deflection angle of a line connecting the calculated adjacent measurement points with respect to a linear direction of the optical fiber, and excludes a measurement point at which an absolute value of the calculated deflection angle is equal to or larger than a predetermined angle from the calculated measurement points, or corrects such a measurement point to a point on a line in a linear direction of the optical fiber.

5. An optical fiber real-space distribution calculation method comprising:
a step of acquiring coordinates of a propagation signal output means for outputting, to an optical fiber in which a plurality of measurement points are set for each predetermined length segment, a propagation signal propagating in a non-contact manner via a vibration medium, and coordinates of a measurement point on the optical fiber; and
a step of calculating coordinates of each measurement point on the optical fiber by recursively repeating calculation of an intersection between a circle centered on coordinates of the measurement point and having a distance of the predetermined length segment as a radius and a circle centered on coordinates of the propagation signal output means as a next measurement point on the optical fiber adjacent to the current measurement point, based on a reception time difference of the propagation signal from the propagation signal output means between the current measurement point and the next measurement point.

6. A non-transitory computer-readable medium storing a program for causing a computer to execute:
processing of acquiring coordinates of a propagation signal output means for outputting, to an optical fiber in which a plurality of measurement points are set for each predetermined length segment, a propagation signal propagating in a non-contact manner via a vibration medium, and coordinates of a measurement point on the optical fiber; and
processing of calculating coordinates of each measurement point on the optical fiber by recursively repeating calculation of an intersection between a circle centered on coordinates of the measurement point and having a distance of the predetermined length segment as a radius and a circle centered on coordinates of the propagation signal output means as a next measurement point on the optical fiber adjacent to the current measurement point, based on a reception time difference of the propagation signal from the propagation signal output means between the current measurement point and the next measurement point.
